(19) United States
(12) Patent Application Publication
(10) Pub. No.: US 2008/0023607 A1
(43) Pub. Date: Jan. 31, 2008

(54) Magnetic-based releasable, adjustable camera or other device mount apparatus

(75) Inventor: John Christopher Barker, Oceanside, OR (US)

Correspondence Address: STEVEN J. ADAMSON, PC, P.O. BOX 5997, PORTLAND, OR, 97228, US

(73) Assignee: Trek Technologies, LLC, dba Trek Tech

(21) Appl. No.: 11/904,790

(22) Filed: Sep. 28, 2007

Related U.S. Application Data
(63) Continuation-in-part of application No. 11/083,676, filed on Mar. 16, 2005.
(60) Provisional application No. 60/554,298, filed on Mar. 17, 2004.

(51) Int. Cl. A47F 5/00; G03B 17/00; H01F 7/02

(52) U.S. Cl. 248/288.51; 248/309.4

(57) ABSTRACT

An apparatus and method for the magnetic-based, releasable and position adjustable attachment of an article to a support. The device is well suited for use with cameras, spotting scopes, navigational devices, distance finders, sensors, lights and other devices, but is not limited to use with these articles. Various embodiments are disclosed including several magnetic-based releasable attachment configurations, various positioning and position locking mechanisms, multiple ways to attach to an ancillary article, and anti-rotation mechanisms, among other aspects of the present invention.

### CROSS-REFERENCE TO RELATED APPLICATIONS

This application is a continuation-in-part of co-pending U.S. patent application Ser. No. 11/083,676, filed Mar. 16, 2005, and entitled Walking Staff having Tripod Base and Adaptable Mount. application Ser. No. 11/083,676 claims the benefit of U.S. Provisional Application No. 60/554,298, filed Mar. 17, 2004, entitled Walking Staff with Tripod Base and having a common inventor.

### FIELD OF THE INVENTION

The present invention relates to the magnetic-based releasable attachment of an item to a mounting mechanism that affords adjustable positioning of the mounted item. The present invention is well suited for use with cameras, spotting scopes, navigational devices, distance finders, sensors, lights and other devices, but is not limited to use with these items.

### BACKGROUND OF THE INVENTION

Various releasable attachment mechanisms are known in the art and they include screw-on, clip-on, magnetic-based and other attachment schemes. The known attachment mechanisms that are made to attach a camera, spotting scope, navigational device and/or other article may have a beneficial purpose, but are disadvantageous for one or more of the following reasons. They may be cumbersome to use, require an undesirable amount of time or effort to achieve attachment, they do not attach with sufficient security and/or they do not afford desired positioning.

It is often desirable to position a camera, sensor or other device once it is mounted to a base structure. Various structures are known for positioning a mounted device. These include ball and socket mounts with a short or long handled set screw and mounts with multiple uniplanar adjustment mechanisms (for example, a pan and tilt head), permitting a user to adjust position in the vertical, horizontal and/or other plane.

Though various devices are known, an unmet need exists for a mount mechanism that affords rapid and secure releasable attachment while also providing ready positioning of the mounted item in a significant range of positions.

### BRIEF DESCRIPTION OF THE DRAWINGS

FIGS. 1-2 is an exploded perspective view and a non-exploded side view of one embodiment of a releasable, position-adjustable mount device.

FIG. 3 is a cross-sectional side view of the device (taken along line 3-3 of FIG. 2) attached to a camera or another device.

FIGS. 4-5 is an exploded perspective view and a non-exploded side elevation view of another embodiment of a releasable, position-adjustable mount device.

FIGS. 6-7 are perspective views of plate and disk of FIG. 4-5.

FIG. 8 is a perspective view of a camera being mounted to walking staff via the patterned plate and disk of FIGS. 6-7.

FIG. 9 is a cross-sectional side view of another embodiment of a releasable, position-adjustable mount device.

FIG. 10 is a perspective view of another embodiment of a releasable, position-adjustable mount device.

### DETAILED DESCRIPTION

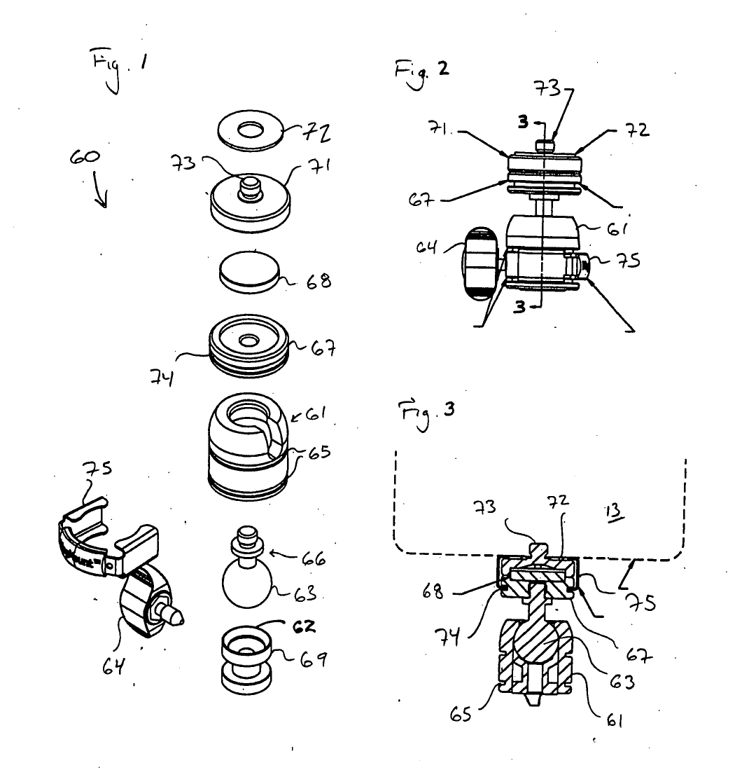

Referring to FIGS. 1-2, an exploded perspective view and a non-exploded side view of one embodiment of a releasable, position-adjustable mount device 60 are respectively shown. Referring to FIG. 3, a cross-sectional side view of the device 60 (taken along line 3-3 of FIG. 2) attached to a camera 15 or another device is shown.

FIG. 1 illustrates various components of device 60 configured to mount to a camera (not shown) or other ancillary article having an appropriate attachment mechanism. The term ancillary article may be used herein to refer to a camera, spotting scope, navigation device, including a distance or angle finder, sensor, light, and any other article to which mount 60 (or other mount embodiments 160, 260, 360) may be mounted.

Body or housing 61 is configured with positioning member 69 to define the socket 62 that holds ball 63. A set screw 64 releasably locks the position of ball 63 within socket 62. Extender 66 protrudes from body 61 and couples to plate 67 in which magnet 68 is mounted. Security clip 75 may clip onto grooves 65 when not in use.

A magnetically active disk 71 is preferably provided for releasable attachment to magnet 68. Threaded member 73 is attached to disk 71 and permits releasable coupling of disk 71 into the threaded recess provided in most cameras, scopes and other items. A spacer washer 72 may be provided about threaded member 73 that is compliant to provide friction at the mount surface and suitably sized to act as a spacer for clip 75.

In FIGS. 2-3, magnetically active disk 71 is shown coupled by magnetic attraction to magnet 68. Magnet 68 is obscured from view in FIG. 2 by plate 67 and disk 71, though visible in the cross-section of FIG. 3. It should be recognized that the position of magnet 68 and the magnetically active material of disk 71 may be reversed.

In FIG. 3, threaded or otherwise fastening member 73 is mounted into a camera 15 or other article. Clamp 75 is moved from its storage position shown in FIG. 2 to its device locking position shown in FIG. 3. In this locking position, clip 75 couples into grooves 74 of plate 67 and onto the top surface of disk 71 adjacent spacer washer 72. While magnet 68 is sufficiently strong to hold a camera or other device without clip 75, clip 75 may be utilized for added security.

It should be recognized that the plate 67 in which the magnet 68 is affixed may be made of non-ferrous or ferrous material. If the plate includes ferrous material than the magnetic field radiating from magnet 68 is enhanced on the side opposite the ferrous material of plate 67, thus the side towards disk 71. This achieves a stronger magnetic connection of disk 71 than when plate 67 is formed of non-ferrous material (or permits use of a magnet of lesser strength).

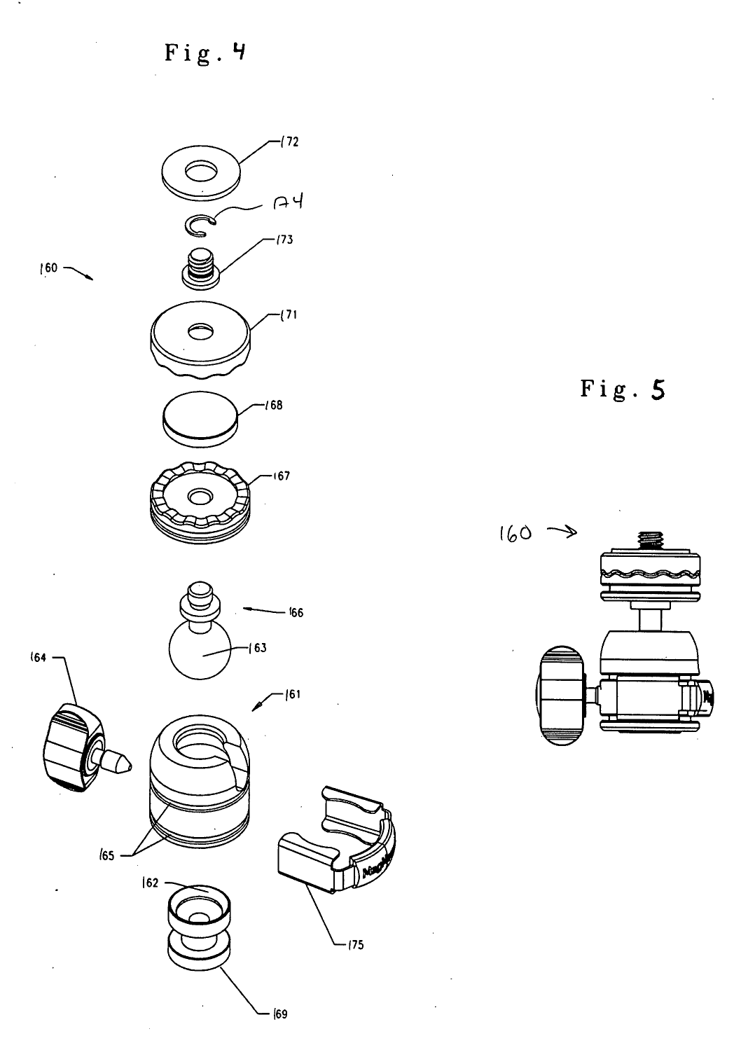

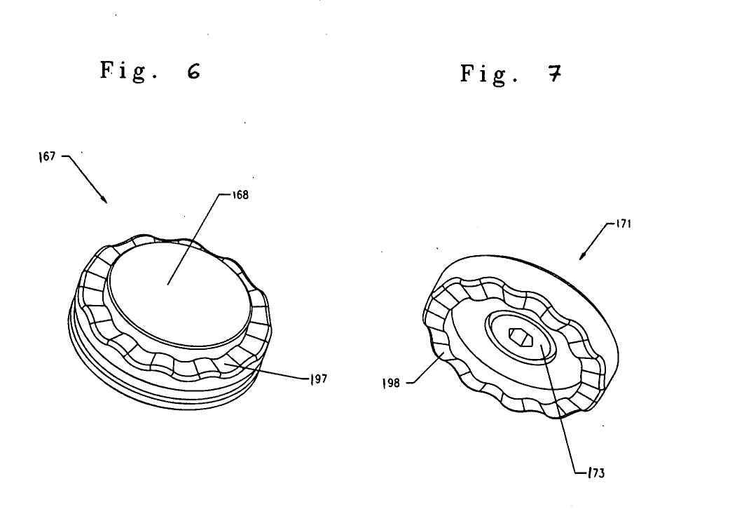

Referring to FIGS. 4-5, an exploded perspective view and a non-exploded side elevation view of another embodiment of a releasable, position-adjustable mount device 160 are respectively shown. FIG. 4 illustrates various components of mount 160 configured to mount to a camera or other ancillary article (not shown) having a standard or otherwise appropriate attachment mechanism 173. Body 161 is configured with positioning member 169 to define the socket 162 that holds ball 163. A set screw 164 releasably locks the position of ball 163 within socket 162. Extender 166 protrudes from body 161 and couples to plate 167 in which magnet 168 is mounted. Security clip 175 may clip onto grooves 165 when not in use.

A magnetically active disk 171 is preferably provided for releasable attachment to magnet 168. Threaded member 173 is attached to disk 171 and permits releasable coupling of disk 171 into the threaded recess provided in most cameras, scopes and other articles. A spacer washer 172 may be provided about threaded member 173 that is compliant to provide friction at the mount surface and suitably sized to act as a spacer for clip 175.

In contrast to the embodiments of FIGS. 1-3, where the threaded member was formed integrally with the magnetically active disk, the embodiment of FIGS. 4-5 illustrate a threaded member that is separate from the disk. The threaded member 173 may include a hex (Allen wrench) or other head that permits it to be screwed into an ancillary article with greater force than the integrated version. The integrated version experiences greater friction as compliant washer 172 is compressed between the disk and the ancillary article. The separate threaded member does not experience the same level of friction and can, therefore, be screwed more tightly.

Referring to FIGS. 6-7, perspective views of plate 167 and disk 171 of FIG. 4-5 are respectively shown. Plate 167 may include a ring or other structure 197 that has a surface patterned with alternating protrusions and recesses. Disk 171 preferably has a ring 198 with complementarily shaped protrusions and/or recesses. In the embodiment of FIGS. 6-7, the ring pattern has a sinusoidal shape, though it should be recognized that any suitable complementary pattern that permits indexing is suitable and within the present invention.

The complementary index pattern of plate 167 and disk 171 is provided for multiple reasons that include the following. When used, for example, to support a camera, a user may wish to tilt the camera at 90 degrees or some other inclination. If the camera has a heavy lens, the weight of the lens may cause the camera to rotate downward, i.e., the strength of the magnet alone may not be sufficient to hold the camera and lens in the desired position. The index pattern provides sufficient resistance to hold a camera with a heavy lens, or other non-balanced load, in a desired position.

In addition, the repeating patterns on the plate and disk permits a user to move a mounted camera (or other article) in fixed intervals. In the embodiment of FIGS. 6-7, the pattern repeats every 30 degrees, permitting a user 12 unique settings at which to position a mounted article.

This indexed arrangement is also beneficial in permitting a photographer to take panorama or landscape photographs, for example, a user can mount a camera on a tripod and position it at regular intervals, enabling the photographer to take (or compile) a 360 degree wide-angle composite photograph.

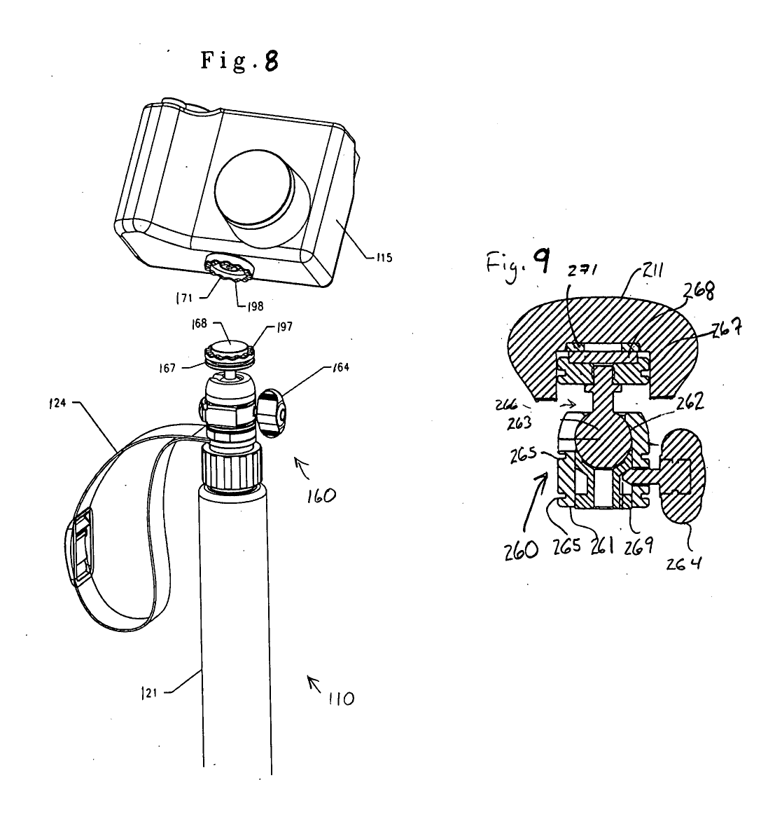

Referring to FIG. 8, a perspective view of a camera 115 being mounted to walking staff 110 via patterned plate 167 and disk 171 is shown. The disk 171 portion of the mount device 160 is preferably screwed into (via threaded member 173) or otherwise mounted to camera 115. The disk may then be seated onto plate 167 and magnet 168. The attraction between magnet 168 and disk 171 is sufficient to hold disk 171 and thereby securely mount camera 115 to the walking staff (with or without the patterned surfaces 197,198).

To position the camera, a user releases set screw 164, positions the camera or other article as desired, via movement of the ball and socket joint, and locks the camera/article into a desired position by resetting the screw.

The complimentary anti-rotation patterning of the plate and disk prevent “slippage” or undesired movement of the camera/article once the position has been set.

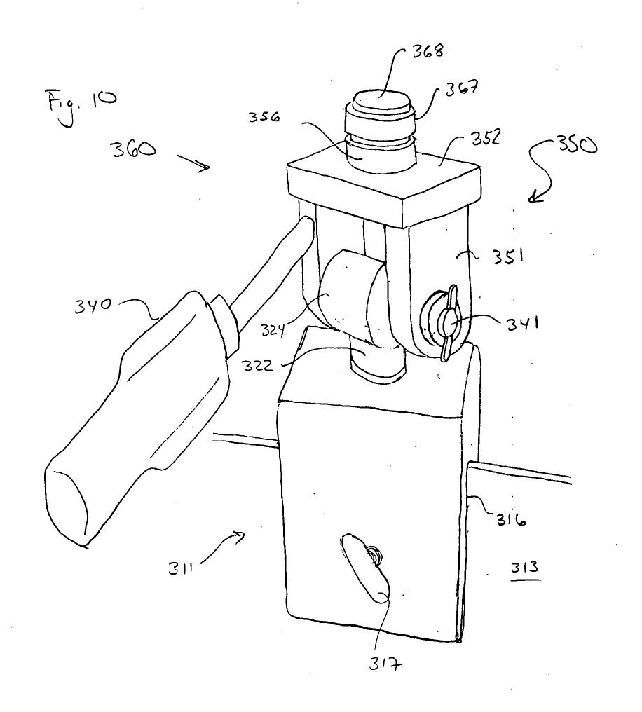

Referring to FIG. 9, a cross-sectional side view of another embodiment of a releasable, position-adjustable mount device 260 is shown. Mount device 260 includes a magnetic active disk 271 that is glued or otherwise attached to a palm rest 211 or other article. FIG. 9 illustrates attachment of disk 271 to an object other than through use of a threaded member (73,173). For example, disk 271 could be glued, welded, or held by other means to any ancillary article. Ancillary articles may include, but are not limited to, articles mentioned elsewhere herein and articles such as a light source or reflector for use in photography, a navigational/surveying device for use in calculating position, distance and/or angle, a sale sign or hook for use in a display rack of a retail store, or in any other situation in which ready releasable and position adjustable attachment of an article is desired.

The ball and socket arrangement shown herein permits a camera or other device to be moved in three mutually orthogonal dimensions. It should be recognized that the present invention includes a magnetic-based releasable and secure attachment in a manner that supports movement of the mounted object in less than three mutually orthogonal dimensions, and other configurations for moving in three mutually orthogonal dimensions.

Mount 260 may include a magnet 268, plate 267, extender 266, security clip grooves 265, set screw 264, ball 263, socket 262, housing 261, and positioning member 269 that include a cavity for releasable attachment of a standard threaded member of other mounting mechanism.

It should be recognized that socket 162 and housing 161 (see FIGS. 4-5) can be releasably or fixedly mounted to the walking staff or other substrate. For example, the socket and/or housing may be configured with a threaded recess that matches a standard tripod or camera mount threaded protrusion (or other complimentary coupling arrangement). Thus, mount device 160 (and 60, 260, 360 herein) may be provided as a stand alone item and mount where or as desired to a multitude of mounting substrates. Alternatively, mounts 60, 160, 260, 360 may be fixedly attached to their substrates by glue, welding or other fixed mechanism.

In yet another embodiment, mounts 60, 160, 260, 360 may be coupled to a clip or other releasable mounting device that permits the mounts to be clipped to a window, a frame or rest structure or other appropriately shaped mount substrate (for example, as discussed below).

Referring to FIG. 10, a perspective view of another embodiment of a releasable, position-adjustable mount device 360 is shown. Mount 360 may incorporate a conventional pan and tilt head or the like 350 that provides movement in two substantially orthogonal planes. It may include a vertical shaft 322 that affords movement in a horizontal plane and a horizontal shaft 324 that affords movement in a vertical plane. While the terms “vertical” and “horizontal” are used with reference to FIG. 10, it should be recognized that they are for pedagogic purposes and the planes need not be vertical, horizontal or orthogonal. Locking handle 340 provides releasable locking of shaft 322, while winged button 341 provides releasable locking of the position of shaft 324.

Mount 360 may include a base plate 352 that is coupled through legs 351 to shaft 324. An adaptor or the like 356 may be mounted to base plate 352 and the legs, base plate and/or adaptor may effectively form an extension member (as do extenders 66, 166, 266).

The adaptor is preferably configured for receiving a plate 367 that holds a magnet 368. Plate 367 and magnet 368 may be configured in a similar manner as the plate and magnet in other embodiments herein and, in the embodiment of FIG. 10, are configured to receive a disk such as disk 71 of FIG. 1. Alternatively, plate 367 may have a patterned ring or the like such as ring 197 of FIG. 6 to receive a complimentary shaped ring such as 198, or be otherwise configured for releasable attachment.

Mount 360 may also include releasable mounting mechanism 311 that receives and supports vertical shaft 322. The mounting mechanism 311 may be releasably mounted to a car window or other structure 313. Mounting mechanism 311 may include a slot 316 and set screw 317 for releasably mounting it to the given structure. Other releasable attachment mechanism configurations, for attachment to differently shaped mounting structures, may be used without departing from the present invention.

The components of the present invention may by made of any suitable material, either now known or later invented. In one embodiment, the releaseable, position-adjustable mount device(s) may be made in part of an aluminum alloy, or otherwise configured including being combined in a forged assembly. The components may be made of metal, plastic or other materials that provide adequate strength, lightness and durability. Ferrous material may be used for the magnetically active material.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A magnetic-based, position adjustable apparatus for attachment of an ancillary article, comprising:
a housing;
an extension member extending from the housing and configured with the housing to be movable in at least two mutually orthogonal dimensions;
a locking mechanism for releasably locking the position of the extension member relative to the housing;
a first of a magnet and corresponding magnetically active member coupled to the extension member and a second of the magnet and magnetically active member geometrically configured with the first to facilitate releasable magnetic-based coupling of the magnet and the magnetically active member; and
attachment mechanism adapted for attachment of an ancillary article to the second of the magnet and magnetically active member so that the ancillary article may be releasably magnetically coupled to the extension member, through the magnet and magnetically active member, and then moved to a desired position relative to the housing and secured in that desired position by the locking mechanism.

2. The apparatus of claim 1, wherein the housing and extension member are configured such that the extension member may be moved up and down and from side to side.

3. The apparatus of claim 1, wherein the housing and extension member are configured such that the extension member may be moved in three mutually orthogonal dimensions.

4. The apparatus of claim 1, wherein the mechanism adapted for attachment to an ancillary article includes a mechanism for releasable attachment to an ancillary article.

5. The apparatus of claim 1, wherein the mechanism for attachment of an ancillary article includes one or more of a threaded member, glue, and a weld.

6. The apparatus of claim 1, wherein the first and second of the magnet and magnetically active material are the magnet and magnetically active material, respectively.

7. The apparatus of claim 1, further comprising an anti-rotation mechanism including a first indexing member associated with the magnet and a second indexing member associated with the magnetically active member;
wherein one of the first and second indexing members includes a plurality of protrusions and the other includes a plurality of recesses, the plurality of protrusions and recesses being formed in a complementary manner so that when the first indexing member and the second indexing member are releasably coupled, the protrusions fit into the recesses and inhibit rotation of the first indexing member relative to the second indexing member.

8. The apparatus of claim 7, wherein the plurality of protrusions and recesses are provided at regular intervals and configured such that the first and second indexing members may be released, moved relative to each other a distance of one or more regular intervals and remounted.

9. The apparatus of claim 1, wherein the housing is configured for releasable attachment to a substrate.

10. The apparatus of claim 1, further comprising a security clip mechanism for clipping about the magnet and magnetically active member when an ancillary article is mounted to the apparatus to provide mechanical-based coupling of the magnet to the magnetically active material.

11. The apparatus of claim 1, wherein the mechanism for attachment to an ancillary article includes a threaded member that is formed separately from the magnetically active member and configured to tighten the magnetically active member to an ancillary article.

12. The apparatus of claim 1, wherein the extension member and locking mechanism are configured for releasably locking the extension member relative to the housing in any of an infinite number of positions.

13. The apparatus of claim 1, wherein the housing, extension member and locking mechanism are configured substantially in a pan and tilt head mechanism.

14. The apparatus of claim 1, wherein the magnet is mounted to a substrate plate that includes ferrous material.

15. A magnetic-based, position adjustable apparatus for attachment of an ancillary article, comprising:
a socket housing defining a socket therein;
a ball configured with the socket to fit movably within the socket;
a releasable position locking member for releasably locking the ball in a given position in the socket;
an extension member extending from the ball and the socket housing;
a first of a magnet and corresponding magnetically active member coupled to the extension member substantially opposite the ball;
a second of the magnet and magnetically active member geometrically configured with the first to facilitate releasable magnetic-based coupling of the magnet and the magnetically active member; and
a mechanism coupled to the second of the magnet and magnetically active member and adapted for attachment to an ancillary article.

16. The apparatus of claim 15, wherein the mechanism adapted for attachment to an ancillary article includes a mechanism for releasable attachment to an ancillary article.

17. The apparatus of claim 15, wherein the socket housing has an opening formed therein of sufficient size and shape to pass the extension member such that the extension member can move between a substantially vertical position and a substantially horizontal position.

18. The apparatus of claim 15, wherein the ball and socket housing are configured such that the magnet and magnetically active member are movable in three mutually orthogonal dimensions.

19. The apparatus of claim 15, wherein the mechanism for attachment of an ancillary article includes one or more of a threaded member, glue, and a weld.

20. The apparatus of claim 15, wherein the first and second of the magnet and magnetically active material are the magnet and magnetically active material, respectively.

21. The apparatus of claim 15, further comprising an anti-rotation mechanism including a first indexing member associated with the magnet and a second indexing member associated with the magnetically active member;
wherein one of the first and second indexing members includes a plurality of protrusions and the other includes a plurality of recesses, the plurality of protrusions and recesses being formed in a complementary manner so that when the first indexing member and the second indexing member are releasably coupled, the protrusions fit into the recesses and inhibit rotation of the first indexing member relative to the second indexing member.

22. The apparatus of claim 21, wherein the plurality of protrusions and recesses are provided at regular intervals and configured such that the first and second indexing members may be released, moved relative to each other a distance of one or more regular intervals and remounted.

24. The apparatus of claim 15, further comprising a security clip mechanism for clipping about the magnet and magnetically active member when an ancillary article is mounted to the apparatus to provide mechanical-based coupling of the magnet to the magnetically active material.

25. The apparatus of claim 20, wherein the mechanism for attachment to an ancillary article includes a threaded member that is formed separately from the magnetically active member and configured to tighten the magnetically active member to an ancillary article.

26. The apparatus of claim 15, wherein the housing and extension member are configured such that the extension member may be moved in three mutually orthogonal dimensions.

27. The apparatus of claim 15, wherein the housing is configured for releasable attachment to a substrate.

28. The apparatus of claim 15, wherein the mechanism for attachment to an ancillary article includes a threaded member that is formed separately from the magnetically active member and configured to tighten the magnetically active member to an ancillary article.

29. The apparatus of claim 15, wherein the housing, extension member and locking mechanism are configured substantially in a pan and tilt head mechanism.

30. The apparatus of claim 15, wherein the housing includes a ball and socket, the ball being coupled to the extension member.

31. A magnetic-based, position adjustable apparatus for attachment of an ancillary article, comprising:
a housing;
an extension member extending from the housing;
a locking mechanism for releasably locking the position of the extension member relative to the housing;
a first of a magnet and corresponding magnetically active member coupled to the extension member and a second of the magnet and magnetically active member geometrically configured with the first to facilitate releasable magnetic-based coupling of the magnet and the magnetically active member; and
attachment mechanism adapted for attachment of an ancillary article to the second of the magnet and magnetically active member so that the ancillary article may be releasably magnetically coupled to the extension member, through the magnet and magnetically active member, and then moved to a desired position relative to the housing and secured in that desired position by the locking mechanism
wherein an ancillary article attached to the apparatus can be moved in a first plane.

32. The apparatus of claim 31, wherein an ancillary article attached to the apparatus can also be moved in a second plane different from the first plane.
